(19) United States
(12) Patent Application Publication
(10) Pub. No.: US 2026/0317244 A1
(43) Pub. Date: Oct. 15, 2026

(54) USING CRYOGENIC LIQUIFIED GAS TO RAPIDLY HARDEN MOLTEN ASPHALT MATERIAL

(71) Applicant: Crafco, Inc., Chandler, AZ (US)

(72) Inventors: Bret ARMSTRONG, Chandler, AZ (US); Todd GLOVER, Chandler, AZ (US); Rich SZYMANSKI, Chandler, AZ (US)

(21) Appl. No.: 19/476,241

(22) PCT Filed: Apr. 19, 2024
(86) PCT No.: PCT/US2024/025523

§ 371 Date: Oct. 17, 2025

Related U.S. Application Data
(60) Provisional application No. 63/460,520, filed on Apr. 19, 2023.

(51) Int. Cl. C04B 40/02; B65B 53/02; C04B 14/28; C04B 26/26; E01C 7/18

(52) U.S. Cl. CPC C04B 40/0254; B65B 53/02; C04B 14/28; C04B 26/26; E01C 7/187

(57) ABSTRACT

A method for rapidly solidifying objects or receptacles containing molten asphalt by contacting the molten asphalt with a cryogenic liquified nonflammable gas, such as liquid nitrogen or liquid carbon dioxide. In a manufacturing facility for making blocks of asphalt sealant, less time and floor space are needed for cooling the blocks. At a job site, remelted asphalt-containing objects or materials can be used for purposes including sealing joints and cracks in pavement surfaces such as cement and asphalt, repairing roofs, or repairing or making pavement, and cryogenic liquified nonflammable gas may be applied at the job site to rapidly resolidify the asphalt.

### CROSS-REFERENCE TO RELATED APPLICATION

This application claims the benefit of U.S. Provisional Patent Application No. 63/460,520 filed Apr. 19, 2023, the disclosure of which is incorporated herein in its entirety.

### TECHNICAL FIELD

The present disclosure is generally related to petroleum-derived products. More specifically, the present disclosure relates to using cryogenic liquified gas to rapidly harden molten asphalt material.

### BACKGROUND

Sealants are used for the sealing of joints and cracks in concrete and asphaltic pavements and parking lots. It is known in the art to deliver packaged blocks of sealant material to a job site, which are then melted in a kettle on-site. The melted sealant can be used to seal joints or fill cracks in the pavement. It is also known in the art to use a material for the packaging which can become incorporated into the molten sealant. For example, U.S. Pat. No. 8,017,681 to Guymon et al. describes adding a thermoplastic product to a formed polymer container, the formed polymer container being an ingredient in the sealant such that the entire container and its contents can be placed in a kettle on the job site and melted. Also known is the use of less-bulky polyolefin film (e.g., polypropylene film) as packaging, as described for example in U.S. Pat. No. 5,452,800 to Muir, for use with roofing asphalt applications, and in U.S. Pat. No. 9,637,252 B2 to Splinter et al., for use with asphalt sealant blocks. Muir uses a water trough for cooling molds containing its molten roofing asphalt product, and Splinter et al. uses a water bath for initial cooling of containers containing its asphalt sealant followed by placing the containers in a wind tunnel.

### SUMMARY OF THE DISCLOSURE

The present disclosure relates to improved techniques for packaging molten asphalt products such as sealants, roofing asphalts and coatings, and to improved techniques for making, coating or repairing pavements using molten asphalt materials. In one aspect, the present disclosure provides a method for forming packaged solidified shaped objects (e.g., blocks, cylinders, tablets, or other shapes) made from molten asphalt and optional additional ingredients, wherein the asphalt is rapidly cooled from a molten to solid state by exposing the molten asphalt to cryogenic liquified nonflammable gas (viz., as a liquid or as the cryogenic vapors thereof). Doing so can significantly reduce the manufacturing footprint (e.g., the floor space and time) required for asphalt solidification. For example, a molten asphalt-containing material may be quickly solidified by spraying or dousing the asphalt material with a cryogenic liquified nonflammable gas such as liquid nitrogen (“LN2”) or liquid carbon dioxide (“LCO2”), submerging the material in a bath of liquified nonflammable gas, or conveying the material through a liquified nonflammable gas-chilled tunnel freezer or a spiral freezer like those used to flash-freeze frozen pizzas prior to distribution. These solidification procedures may for example be performed indoors, e.g., inside a manufacturing facility.

In embodiments, the disclosed solidified shaped objects may be at least partially enveloped by a sheet of packaging film (e.g., thermoplastic material such as polypropylene film) to form a self-sealed package of one or more shaped objects that can be added to and melted in a heated kettle at a job site. The packaging film acts as an inexpensive, easily stored container that can be melted into the kettle contents at the job site. When the job site molten material is a roofing asphalt, the roofing asphalt may be rolled, brushed, squeegeed, sprayed or otherwise applied to a new or existing roof surface. When the job site molten material is an asphalt sealant, the sealant may be injected, rolled, brushed, squeegeed, sprayed or otherwise applied to joints or cracks within an asphaltic or concrete structure, such as a sidewalk, pavement (e.g., a road, driveway, runway or parking lot), a wall, embankment, levee, building, or the like to fill the joint or crack. When the job site molten material is an asphaltic coating, the coating may be rolled, brushed, squeegeed, sprayed or otherwise applied to coat a surface of such an asphaltic or concrete structure.

In another aspect, a cryogenic liquified nonflammable gas (e.g., LN2 or LCO2) may once again be applied to the job site molten material at its application location to complete the construction or repair significantly more rapidly. As one illustrative example, a road may be temporarily closed so that cracks or potholes may be filled with asphalt sealant. According to the techniques described herein, the applied sealant may be hardened, and the road reopened to vehicle traffic within a matter of minutes, rather than after hours or even days, thereby significantly alleviating traffic congestion during the road repair.

In another aspect, pavement may be made or repaired by applying an asphalt-containing pavement mix (viz., a heated mixture comprising molten asphalt, finely-divided aggregate, and optionally other ingredients) to a suitable base or a suitable underlying pavement layer, and hardening the mix by contacting it with cryogenic liquified nonflammable gas. Doing so enables use or resumed use of the pavement (e.g., for traffic or parking) more quickly than would be possible using air cooling or the application of water to cool the pavement.

In another aspect, a roof may be coated or repaired by applying a molten asphalt-containing material to a new or existing roof surface, and hardening the material by contacting it with cryogenic liquified nonflammable gas.

Other objects, advantages, features, properties and relationships of the disclosure will be obtained from the following detailed description and accompanying drawing which set forth illustrative embodiments that are indicative of the various ways in which the principles of the disclosure may be employed.

### BRIEF DESCRIPTION OF THE DRAWING

FIG. 1 is a top perspective view of a container for receiving a volume of asphalt-sealant material;

FIG. 2 is a top perspective view of the container of FIG. 1 lined with a sheet;

FIG. 3 is a top perspective view of the sheet-lined container of FIG. 2 with asphalt sealant placed therein;

FIG. 4 is a side view, partially in phantom, of a cryogenic cooling machine used to rapidly solidify blocks of asphalt sealant;

FIG. 5 is a top perspective view of a block of cooled sealant removed from the container of FIGS. 1-3, and covered with the sheet of FIGS. 2 and 3;

FIG. 6 is a top perspective view of three film-wrapped blocks of cooled sealant stacked together;

FIG. 7 is a conceptual diagram showing the three blocks of cooled sealant of FIG. 6, both before and after being stacked together;

FIG. 8 is a top perspective view of the three stacked blocks of cooled sealant of FIGS. 6 and 7 wrapped in a film;

FIG. 9 is a flowchart illustrating a method of packaging an asphalt-sealant product;

FIG. 10 is a perspective view illustrating applying an asphalt-containing material to a roof and hardening the material with a cryogenic gas; and

FIG. 11 is a perspective view illustrating applying an asphalt-containing material to pavement and hardening the material with a cryogenic gas.

### DETAILED DESCRIPTION

The recitation of a numerical range using endpoints includes all numbers subsumed within that range (e.g., 1 to 5 includes 1, 1.5, 2, 2.75, 3, 3.80, 4, 5, etc.).

The terms “a,” “an,” “the,” “at least one,” and “one or more” are used interchangeably. Thus, for example, a sealant composition that contains “an” additive means that the composition includes “one or more” additives.

The term “aggregate” refers to particulate mineral material such as limestone, granite, trap rock, gravel, crushed gravel sand, crushed stone, crushed rock and slag useful in paving and pavement applications.

The term “asphalt” (also referred to in some jurisdictions as “bitumen”) refers to a class of black or dark-colored (solid, semisolid, or viscous) cementitious substances, natural or manufactured, composed principally of high molecular weight hydrocarbons, and typically including components such as saturates, aromatics, resins and asphaltenes.

The term “asphalt binder” refers to a material including bitumen and optionally other components that is suitable for mixing with aggregate to make a paving mix.

The terms “asphalt paving mixture” or “asphalt mix” or “mix” refer to an uncompacted mixture of asphalt and aggregate. Depending on local usage, the terms “bitumen mix” or “bituminous mixture” may be used interchangeably with or in place of the terms “asphalt paving mixture” or “asphalt mix” or “mix.”

The term “asphalt sealant” refers to an asphalt-containing material that can be used to fill cracks or gaps in a surface or structure.

The term “cryogenic” when used in connection with a gas, means that the gas has an atmospheric pressure boiling point less than −50 °C (−58 °F).

The term “elastomer” refers to its definition in ASTM D1566 as a “macromolecular material that returns rapidly to approximately the initial dimensions and shape after substantial deformation by a weak stress and release of the stress.” An “elastomeric material” is a material having the properties of an elastomer as provided by ASTM D1566.

The term “liquified” when used in connection with a substance that is normally a gas at atmospheric pressure, means that the substance has been stored at a pressure and temperature sufficient for the substance to be in liquid form.

The term “nonflammable” when used in connection with a liquified gas means that the gas is not easily ignitable. Examples of flammable gases include liquid propane, liquified natural gas, and liquid hydrogen.

The term “reusable” refers to materials that are capable of repeated use over a period of time without exhibiting any significant degradation warranting removal from use.

The term “stretchable” refers to materials that can be stretched out, extended, elongated, or lengthened upon application of a force or stress against the materials. A stretchable material may comprise an elastomeric material (e.g., silicone) or a non-elastomeric material (e.g., nylon).

The present disclosure describes exemplary techniques for rapidly cooling products and materials containing molten asphalt (e.g., asphalt sealant, an asphalt sealant product, or an asphalt-containing coating) using a cryogenic liquified nonflammable gas (or in the interest of brevity, a “cryogenic gas”). Exemplary such gases include elemental gases (e.g., nitrogen, helium and argon), molecular gases (e.g., carbon dioxide and nitrous oxide), and mixtures of gases. Preferred cryogenic gases are nontoxic (e.g., a gas other than ammonia). In addition, preferred cryogenic gases do not support combustion (e.g., a gas other than liquid oxygen or liquified nitrous oxide).

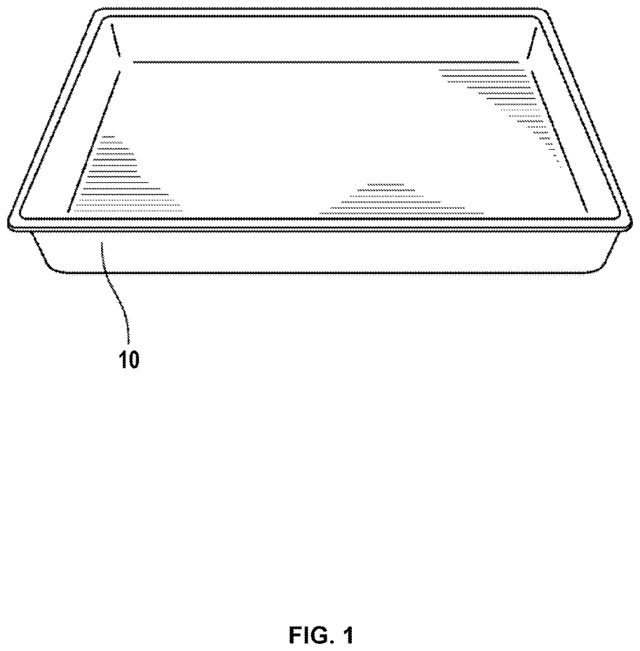

FIG. 1 shows a generally rectangular container 10 configured to receive a volume of molten sealant material, as detailed further below. Container 10 can include or can be a mold, a pan, a box, or another suitable receptacle, comprised of aluminum, silicone, or other suitable materials. In embodiments, container 10 may have a thickness of about 25 mm to about 127 mm (about 1 inch to about 5 inches), a width of about 25 cm to about 51 cm (about 10 inches to about 20 inches), and a length of about 38 cm to about 76 cm (about 15 inches to about 30 inches). Exemplary dimensions of container 10 are 76 mm by 36 cm by 56 cm (3 inches by 14 inches by 22 inches), although other dimensions are contemplated, and a container of suitable dimensions (and shapes) may be used.

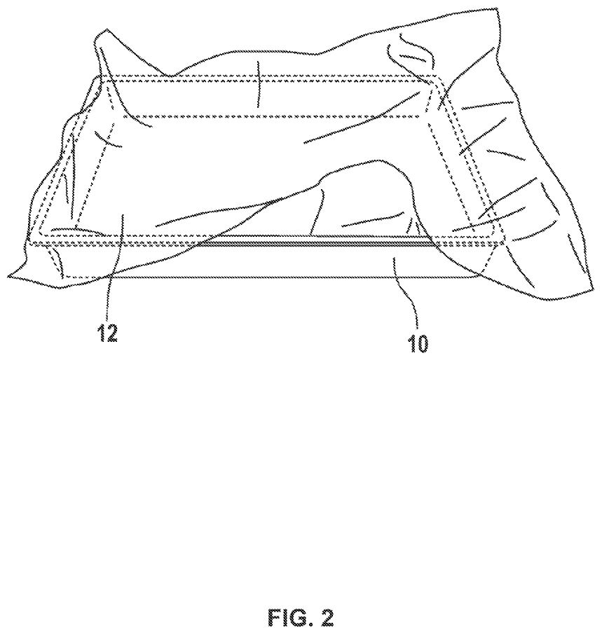

As shown in FIG. 2, container 10 is draped or lined with an inexpensive, easily stored, flexible sheet 12 configured to form a low-profile packaging wrapper for a block of asphalt sealant. As detailed further below, sheet 12 is further configured to melt when the final packaged sealant product is placed into a kettle at a job site and heated, at which time, sheet 12 forms part of the end product for filling cracks and joints in, or for coating, concrete, pavement, asphalt, or other surfaces. In some examples, sheet 12 is formed from a polymer such as polypropylene, or a similar material. Polypropylene molecules are long, carbon chains with only methyl functional groups, and are very compatible with asphalt—there are no significant chemical reactions that take place between the polypropylene and the asphalt material, or any other components of the sealant. Accordingly, after melting into the asphalt sealant, the polypropylene film merely becomes a filler material, comprising approximately 0.2% of the sealant.

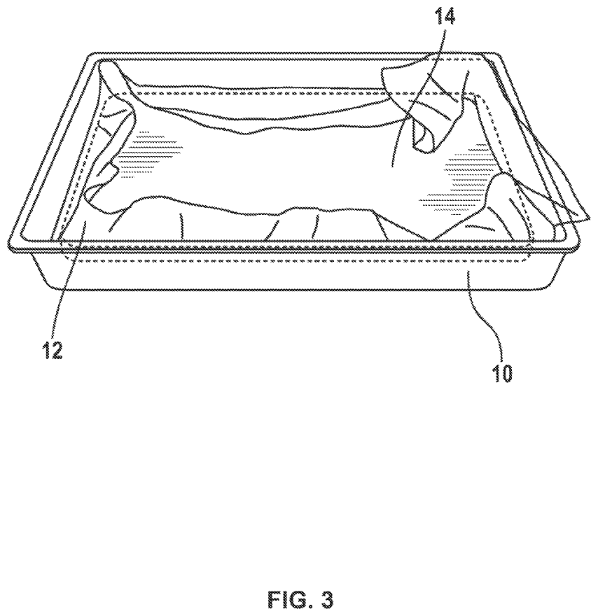

As shown in FIG. 3, a molten (e.g., hot, liquid) sealant material 14 is poured over sheet 12 within container 10. Sealant material 14 may comprise any suitable composition appropriate for filling cracks and joints in, or for coating, concrete and asphaltic pavements, roofs, and other architectural structures. One example of a suitable sealant material 14 is a composition of asphalt binder, petroleum oil, a thermoplastic polymer, and limestone, although other suitable sealant materials are contemplated and may be used. In embodiments, sealant material 14 may comprise an amorphous asphalt-containing material. Sealant material 14 is compatible with the material of sheet 12 such that sheet 12 naturally adheres to sealant 14 after sealant 14 is poured into container 10. For instance, sheet 12 may be comprised of extrusion-grade polypropylene.

As sealant 14 fills container 12, the force of molten sealant 14 self-leveling and taking the shape of container 10 causes sheet 12 to naturally reposition itself against the interior surfaces of container 10. In the example shown in FIG. 3, sheet 12 is sized such that, when sealant 14 fills container 10 and repositions sheet 12, sheet 12 covers all four lateral sides of sealant 14, as well as a portion of the top surface of the sealant volume, and preferably leaves at least a portion of the top surface exposed. Alternatively (not shown), sheet 12 can be sized to provide extra area around each side of container 10 so that extra material of sheet 12 can be folded over the top of the filled container 10, e.g., fully covering the top surface of sealant 14 in addition to all surfaces inside the container 10. Sheet 12 protects sealant 10 from exposure, e.g., during transport and while in storage before use at a job site. Sheet 12 further allows easy handling of sealant 14 for transport and placement into a melting kettle at the job site.

After lined container 10 is filled with molten sealant material 14, the container 10, sheet 12, and sealant 14 can be actively cooled with a cryogenic gas to harden sealant 14 into a solid state, which generally occurs at or below about 49°-54 °C (120°-130 °F). In some but not all embodiments, container 10 may initially be placed onto a conveyor, such as a steel belt, which travels through a water bath for a preliminary round of cooling. In some such embodiments, a chiller may be used to maintain the water at a sufficiently cold temperature.

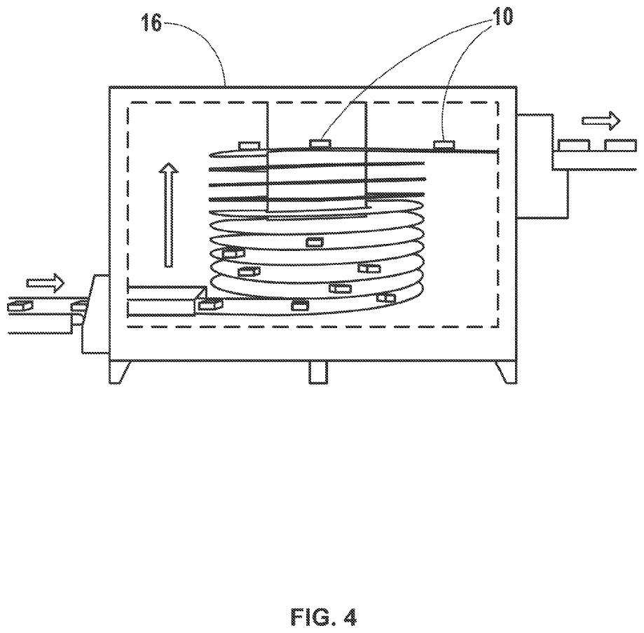

In accordance with techniques of this disclosure, filled container 10 undergoes rapid cooling by contacting sealant 14 (e.g., the top surface of sealant 14) with the liquified or vaporized form of a cryogenic gas, such as liquid nitrogen (“LN2”) or liquid carbon dioxide (“LCO2”). For instance, in the embodiment shown in FIG. 4, filled containers 10 are fed into a cryogenic freezer 16, such as a “tunnel freezer” or “spiral freezer,” of the kind typically used to flash-freeze frozen pizzas for mass-distribution. Non-limiting examples of such cryogenic freezers are the Cryoline® CryoVantage Tunnel Freezer and the Cryoline® Ultra-Performance Spiral Freezer, both available from Linde plc of Dublin, Ireland. Using a cryogenic gas to rapidly cool a product or article containing molten asphalt allows the cooling process to be completed in a matter of minutes (e.g., on the order of 30 minutes or less, depending on factors including the initial pour temperature, container size, ambient conditions, production rate, presence of nearby heat sources or heat sinks, and so on), rather than taking several hours or even several days using standard cooling techniques. In fact, it is estimated that for the manufacture of asphalt sealant blocks, eliminating this current bottleneck in sealant block packaging, the manufacturing footprint (e.g., the amount of time and factory-floor space) required to manufacture each sealant block may slashed by up to one-half or even more, or alternatively may enable the packaged sealant block production rate to be doubled or even more than doubled. Sealant block manufacturing facilities that implement this new rapid-cooling technique will typically be located indoors, and the associated cryogenic storage container, such as an LN2 tank, will typically be located above ground outside the manufacturing facility.

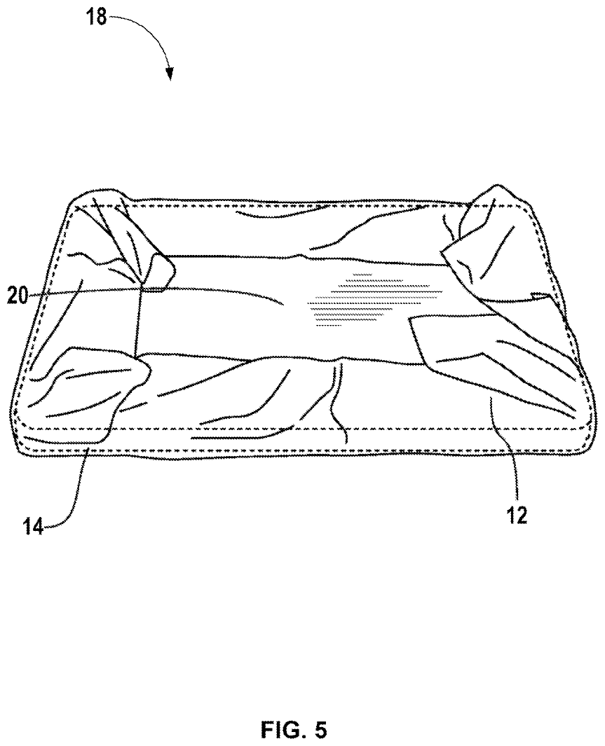

As shown in FIG. 5, once sealant material 14 has been cryogenically cooled to a solid state, a solid block 18 is produced, which includes sealant 14 with sheet 12 adhered to (e.g., fixedly wrapped around) the sides and a portion of the top 20 of sealant 14. In embodiments, the rate of cooling and composition of the sealant are such that the cooled and solidified block 18 is crack-free. In other embodiments, the rate of cooling and composition of the sealant are such that the cooled and solidified block 18 includes cracks. The inclusion of cracks in the solidified sealant product may be desirable, to speed the rate of remelting when block 18 is remelted in a kettle at a job site. In any event, wrapped block 18 may be removed from container 10, while leaving sheet 12 around block 18 for easy handling, and with sheet 12 not requiring removal from block 18 before sealant block 18 is remelted at the job site. In addition to providing packaging for sealant block 18, sheet 12 also acts as a release liner, allowing easy removal of sealant block 18 from container 10.

In some examples, container 10 may be made from a silicone material (e.g., may comprise a silicone mold). When made from a silicone material, container 10 does not need to be draped or lined with sheet 12 because of the low surface energy properties of silicone (e.g., no sticking because the silicone material only bonds to itself). Container 10 made from a silicone material can be stretchable, reusable, and have low surface energy such that the sealant block 18 can be removed without damaging the container 10. Container 10 may then be subject to the sealant pouring and rapid cryogenic cooling operations described previously, and preferably not be affected by such operations. Alternatively, the sealant material 14 inside a silicone container 10 may be hardened through ambient air cooling rather than rapid cryogenic cooling. In both instances, a hardened solid block 18 of sealant material is produced and can be removed from the silicone container 10 for further operations as described herein. Further disclosure regarding container 10 made from a silicone material is provided in a co-pending PCT Application filed even date herewith under Attorney Docket No. 569079-39, the disclosure of which is incorporated herein in its entirety.

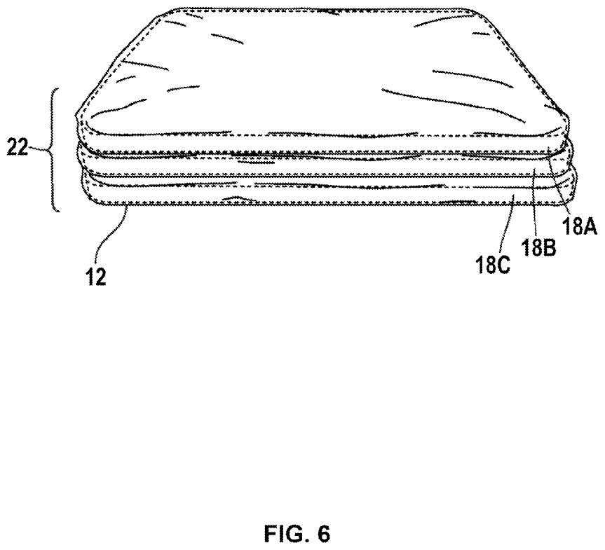

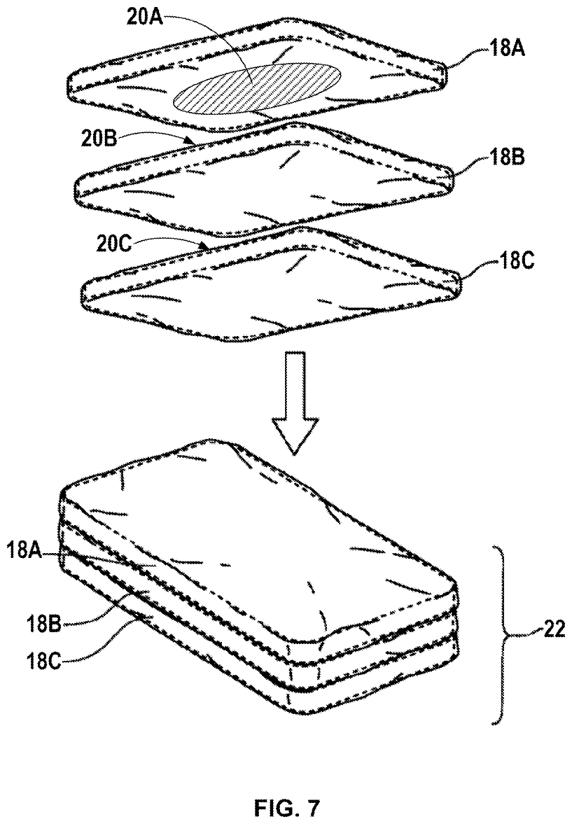

In embodiments (such as the embodiment depicted in FIG. 5), when cooled sealant block 18 is removed from container 10, sheet 12 covers all sides of sealant block 18 and a portion of the top surface 20 of block 18. As shown in FIGS. 6 and 7, multiple covered sealant blocks 18A-18C may be placed together to form a self-sealed package 22 of two or more sealant blocks 18. In embodiments, container 10 (FIGS. 1-3) is sized to create finished sealant blocks 18 weighing approximately 4.5 Kg (10 lbs.). In some such embodiments, three individual sealant blocks 18A-18C may then be self-sealed together to produce an approximately 13.6 Kg (30 lb.) package 22, which permits easy handling and allows the entire package 22 to fit into a melting kettle for use at a job site. Container 10 can alternatively be sized to produce sealant blocks 18 of varying sizes, as well as packages 22 comprised of varying numbers of sealant blocks 18 and having varying total weights.

As shown in FIG. 7, to create package 22, two or more contained sealant blocks 18A, 18B, and 18C are stacked together, with the at-least-partially uncovered surfaces 20A, 20B, of two blocks 18A, 18B, respectively, placed adjacent to (viz., facing) one another, and the at least partially uncovered surface 20C of any additional blocks 18C placed on the bottom of the stack of two, forming a package 22 of two or more blocks 18A-18C, self-sealed by sheets 12.

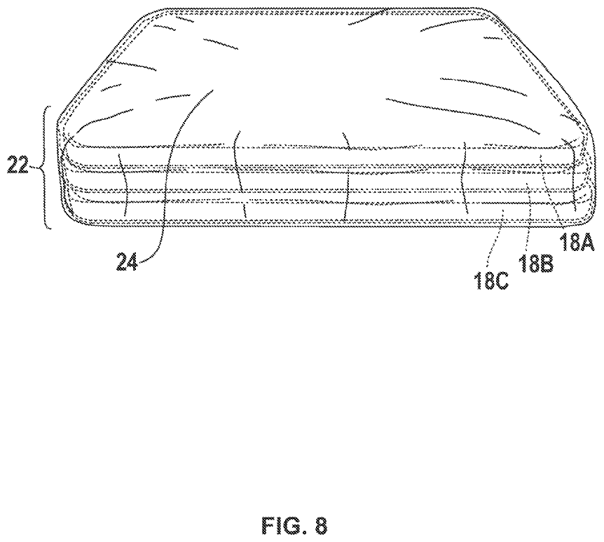

As shown in FIG. 8, package 22 can optionally be further wrapped in a film 24 comprised of a material that, when heated past its melting point, mixes together with sealant material 14 and sheet 12 to become part of the end sealant product. Additional film 24 ensures a complete seal around package 22 for transport. In embodiments, self-sealed package 22 is placed on a pallet (not shown in FIG. 8) and wrapped using a shrink-wrap machine with a suitable film 24. Using a shrink-wrap version of film 24 helps give the pallet stability and weather-proofs the sealant.

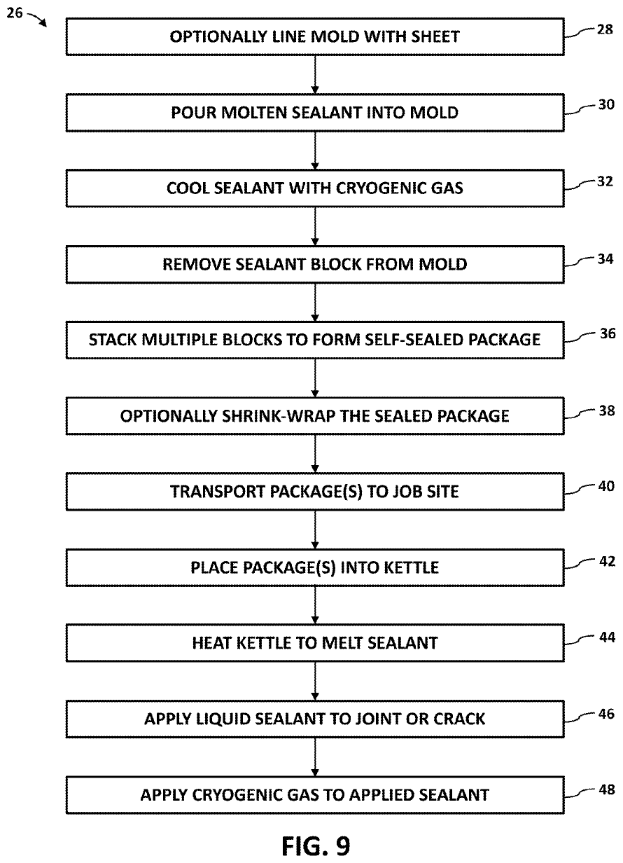

FIG. 9 is a flowchart 26 illustrating a method of forming and packaging a sealant product, as shown and described above with respect to FIGS. 1-8. The method includes optionally lining a container or container 10 with a sheet 12, such as a polypropylene film (28) (sheet 12 is generally not required if container 10 is made from a silicone material). A hot, molten sealant material 14 is then poured atop sheet 12 within container 10 (30). As described above, filled container 10 is fed through a cryogenic cooling machine 16, such as a tunnel cooler or a spiral cooler, configured to bombard molten sealant 14 with a cryogenic gas, such as LN2 or LCO2 (32), causing sealant 14 to rapidly harden into a solid block 18. Solid block 18 (e.g., hardened sealant material 14 optionally wrapped in sheet 12) can be removed from container 10 (34) and stacked with one or more additional blocks to form a sealed package 22 (36). Optionally, package 22 can be wrapped in an additional film layer 24, such as shrink-wrap, to ensure retention between the blocks (38). Once sufficiently sealed, packages 22 may be transported to a job site (40) and placed into a kettle (42).

As described above, where a sealant block 18 is dimensioned to weigh approximately 4.5 Kg, three individual sealant blocks 18 may be stacked together to form a three-block package 22 weighing approximately 13.6 Kg. Packages 22 of this approximate size and weight fit into standard-sized melting kettles, and also allow for easy lifting of packages 22 from pallets, conveyors, or other methods or devices for transporting packages 22 into melting kettles on site. However, also consistent with this disclosure are individual sealant blocks 18 formed in containers 10 with varying dimensions to result in sealant blocks 18 with varying sizes and weights. For example, two sealant blocks 18 of approximately 6.8 Kg (15 lb.) each, or any other suitable combination of block number and weight, may be joined to form an approximately 13.6 Kg package 22.

The job site kettle may then be heated until sealant material 14, film 12, and film 24 (if present) melt and mix together, forming a liquid sealant (44). Simultaneously melting multiple smaller blocks 18 in the melting kettle has the key advantage of allowing sealant blocks 18 of package 22 to melt faster and more evenly than systems using use one large sealant block. For instance, when package 22 is placed into an oil-jacketed melting kettle and heated to approximately 188 °C (370 °F), film 24, sheet(s) 12 and sealant material 14 melt to form the final liquid sealant product. As sealant material 14 begins to melt, package 22 separates. Molten sealant migrates into the spaces between individual sealant blocks 18 and accelerates the melting process. This allows a greater surface area of still-solid sealant material 14 to be exposed to hot liquid sealant more quickly, allowing package 22 to melt approximately two-and-a-half-times faster than traditional systems that use just one large block of sealant material. The use of multiple, smaller blocks 18 as opposed to one large block of material also allows blocks 18 to melt more evenly than melting one large block of material.

When film 24, sheet 12, and sealant material 14 are melted and mixed together, the final liquid sealant product may be removed from the kettle and used for repairs or coatings. For example, sealant material 14 may be placed into cracks or joints of asphalt or pavement (46). The above-described cooling procedures may also be used to bring a suitable cryogenic gas (e.g., LN2 or LCO2) into contact with the applied liquid sealant to rapidly solidify the new seal (48). For instance, by using liquid nitrogen to rapidly freeze a sealed crack in a road, the road can be re-opened to vehicle traffic within just minutes after sealing the crack, thereby alleviating local traffic congestion. The cooling procedures will generally be like the procedures described above, but typically will occur outdoors, and preferably will avoid crack formation during or because of the cooling procedures.

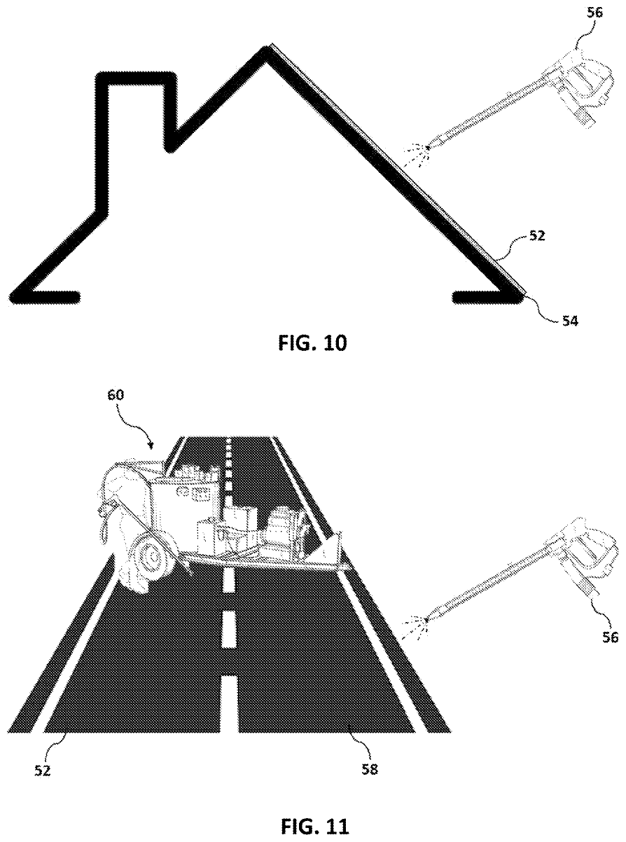

Referring now to FIG. 10, the above-described cooling procedures may be used to repair existing roofs and to create new roofs made from asphalt-containing materials. As illustrated, a roof 54 of a house or other architectural structure may be coated or repaired by applying an asphalt-containing material 52 to a new or existing roof surface 54. The asphalt-containing material 52 may be hardened by contacting the material 52 with a cryogenic liquified nonflammable gas 56 to create a finished asphalt surface quicker than conventional hardening methods (e.g., air cooling).

The cryogenic gas 56 may be supplied from a mobile gas-containing unit or can be supplied from a stationary gas-containing unit and delivered via a hose or tube to the asphalt-containing material 52. Cryogenic gas 56 may be provided directly after the asphalt-containing material 52 is applied to the roof surface 54, or may be provided after a period of time depending on the roofing requirements (e.g., size of the roof, type of asphalt-containing material used). In embodiments, the cryogenic gas 56 is a non-combustible gas, for example a gas other than liquid oxygen or liquified nitrous oxide (e.g., a non-oxygen liquified gas).

The above-described cooling procedures may be used with asphalt-containing materials 54 including shingles, rolled roofing, and hot-applied roofing. Shingles are advantageous given their wide availability in North America, ease of installation, and low costs. Common asphalt-containing shingle types are strip shingles, dimensional shingles, and luxury shingles, each of which provides advantages in certain situations. Rolled roofing is a low cost and easy to install alternative to shingles used most frequently with low-incline roofs. Unlike shingles which are installed one-by-one, rolled roofing can be quickly rolled outward from a bundle to repair an existing roof or to create a new covered roof. Rolled roofing tends to be less durable than shingles given how a network of shingles is loosely interlocked to enable expansion and contraction without stressing individual shingles. As the name suggests, hot-applied roofing is generally applied to a roof surface with heat to adhere the material to the roof surface or to seal seams depending on how the material is used. Hot-applied roofing is of particular interest to the present disclosure given the need to cool the heated material which can be achieved using the above-described cryogenic gas cooling procedures.

Accordingly, the above-described cooling procedures may also be used to more quickly harden roofing asphalts and coatings that have been rolled, brushed, squeegeed, sprayed or otherwise applied to a new or existing roof surface. The cooling procedures typically will take place outdoors, and preferably will avoid crack formation during or because of the cooling procedures. As a result, applying the cooling procedures to repair existing roofs and to create new roofs made from asphalt-containing materials enables quicker construction times without loss of material properties or roof structural integrity.

Referring now to FIG. 11, the above-described cooling procedures may be used to repair existing pavement and to create new pavement for vehicle transportation. As illustrated, a pavement 58 of a road may be coated or repaired by applying an asphalt-containing material 52 to a new or existing pavement surface 58. The asphalt-containing material 52, which can be deposited from a vehicle 60, may be hardened by contacting the material 52 with a cryogenic liquified nonflammable gas 56 to create a finished asphalt surface quicker than conventional hardening methods (e.g., air cooling). The cryogenic gas 56 may have the same properties as when used for the roofing operations described previously.

The asphalt-containing material 52 may comprise porous asphalt, quiet pavement asphalt, hot-applied or warm-applied asphalt, or thin overlay asphalt, for example. Porous asphalt generally comprises standard asphalt in which the fine particles have been screened and reduced to create void space to make the asphalt highly permeable to water. Porous asphalt is typically used in vehicle parking lots to enable water or other fluids to drain through the pavement. Quiet pavement asphalt is generally a stone-matrix asphalt or an open-grade friction course asphalt mix which can reduce noise as vehicles travel over the pavement. Hot-applied and warm-applied asphalt are generally made from a mix of fine and coarse aggregate and asphalt binder to produce pavement that is highly weather-resistant. In embodiments, the asphalt binder may be approximately 1 to 5 wt. % of the mixture of binder and aggregate. Hot-applied and warm-applied asphalt are heated and poured at high temperatures (e.g., 149°-176 °C, or 300°-350 °F) for common grades of hot-applied asphalt, and at generally lower temperatures for common grades of warm-applied asphalt). Thin overlay asphalts are generally a mix of hot-applied or warm-applied asphalt and recycled materials to form a pavement with improved vehicle ride quality and reduced vehicle travel noise. As with roofing, hot-applied and warm-applied asphalt for pavement is of particular interest to the present disclosure given the need to cool the heated material which can be achieved using the above-described cryogenic gas cooling procedures.

The above-described cooling procedures may also be used to more quickly harden an asphalt-containing pavement mix that has been applied to and compacted atop a suitable base or a suitable underlying pavement layer. Doing so enables use or resumed use of the pavement (e.g., for traffic across a roadway or parking in a parking lot) more quickly than would be possible using air cooling or the application of water to cool the pavement. The cooling procedures typically will take place outdoors, and preferably will avoid crack formation during or as a result of the cooling procedures.

The cooling procedures described herein may also be used with various pavement surface treatments, including chip seal, fog seal, and scrub seal. Chip seal (e.g., asphaltic surface treatment) combines one or more layers of asphalt with one or more layers of fine aggregate on a pavement surface. Chip seals are typically used on rural roads carrying lower traffic volumes but may also be used on major roadways. Fog seal is the application of an asphalt emulsion (e.g., a thin liquid oil emulsion, such as an oil in water or water in oil emulsion with asphalt particles in the oil phase) to an existing pavement surface to seal narrow cracks, restore lost flexibility to the pavement surface, and to help preserve the underlying pavement structure. Asphalt emulsions used in fog seals generally contain asphalt, water, an emulsifying agent or surfactant (e.g., soap), and occasionally an asphalt additive (e.g., rejuvenators, anti-aging additives). Scrub seal is very similar to fog seal except that the asphalt emulsion used in the treatment is generally applied to the pavement surface using a series of brooms placed at different angles. The brooms guide the asphalt emulsion into cracks in the pavement to seal the cracks. The disclosed cooling procedures may be used to harden pavements undergoing chip seal, fog seal, or scrub seal treatments more quickly.

While specific embodiments of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure, which is to be given the full breadth of the appended claims and any functional equivalents thereof.

1. A method comprising the steps of:
providing a container having a depth of about 25 mm to about 127 mm (about 1 inch to about 5 inches);
placing a molten volume of asphalt material into the container;
applying a cryogenic liquified nonflammable gas to the asphalt material within the container to rapidly cool and solidify the asphalt material, thereby forming an asphalt block comprising the asphalt material and having a thickness of about 25 mm to about 127 mm (about 1 inch to about 5 inches); and
removing the asphalt block from the container.

2. The method of claim 1, wherein the asphalt material comprises asphalt binder.

3-4. (canceled)

5. The method of claim 1, wherein the asphalt material comprises asphalt binder, oil, a thermoplastic polymer, and limestone.

6-7. (canceled)

8. The method of claim 1, wherein applying the cryogenic gas to the asphalt material comprises feeding the container through a cryogenic freezer.

9. The method of claim 8, wherein the cryogenic freezer comprises a tunnel freezer or spiral freezer.

10. (canceled)

11. The method of claim 1, wherein applying the cryogenic gas to the asphalt material comprises spraying the sealant material with the cryogenic gas.

12. The method of claim 1, wherein applying the cryogenic gas to the asphalt material comprises submerging the asphalt material in a bath of the cryogenic gas.

13. The method of claim 1, wherein the cryogenic gas is applied to the asphalt material at a rate sufficient to harden the asphalt material without cracking the asphalt block.

14. The method of claim 1, wherein the cryogenic gas is applied to the asphalt material at a rate sufficient to harden the asphalt material and to have one or more cracks form in the asphalt block.

15. The method of claim 1, wherein the cryogenic gas is nontoxic and does not support combustion, and wherein solidification of the asphalt material takes ten minutes or less.

16. (canceled)

17. The method claim 1, wherein the cryogenic gas comprises liquid nitrogen.

18. The method of claim 1, wherein the cryogenic gas comprises liquid carbon dioxide.

19. (canceled)

20. The method of claim 1, wherein the asphalt block has a first exposed portion, and the method further comprises positioning the first exposed portion against a second exposed portion of a second asphalt block to form a self-sealed asphalt package.

21. (canceled)

22. The method of claim 20, further comprising wrapping the self-sealed asphalt package with a film having a material that, when heated past its melting point, mixes together with the asphalt material to become part of an end asphalt product.

23-24. (canceled)

25. The method of claim 1, further comprising:
lining the container with a sheet,
wherein the molten volume of the asphalt material is provided onto the sheet lining the container, and
wherein the formed asphalt block comprising the asphalt material is at least partially wrapped in the sheet.

26. (canceled)

27. The method of claim 25, wherein the sheet is made from a thermoplastic material.

28. The method of claim 27, wherein the thermoplastic material comprises polypropylene.

29. The method of claim 1, wherein the container is made from a silicone material that is stretchable, elastomeric and reusable.

30. (canceled)

31. The method of claim 1, wherein the container is made from aluminum.

32. The method of claim 1, wherein the container has a rectangular geometry, a width of about 25 cm to about 51 cm (about 10 inches to about 20 inches), and a length of about 38 cm to about 76 cm (about 15 inches to about 30 inches), and forms an asphalt block that can be hand-carried.

33-74. (canceled)
